(19) United States
(12) Patent Application Publication
(10) Pub. No.: US 2007/0024348 A1
(43) Pub. Date: Feb. 1, 2007

(54) Charge pump circuit of switching source

(75) Inventor: Kazuaki Nakayama, Tokyo (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/493,855

(22) Filed: Jul. 27, 2006

(30) Foreign Application Priority Data
Jul. 29, 2005 (JP) P2005-221417

(51) Int. Cl. G05F 1/10

(52) U.S. Cl. 327/536

(57) ABSTRACT

A charge pump circuit of a switching source includes: a transformer; a rectifier diode of a secondary side of the transformer located at a ground side of a secondary winding wire; a capacitor for a charge pump; a power source of which a voltage is applied so as to charge accumulated in the capacitor; and a boosting transistor connected between the capacitor and the power source. A transformer voltage generated at a cathode side of the rectifier diode is at least partially used as a gate-driving voltage of the boosting transistor.

### CROSS-REFERENCE TO RELATED APPLICATIONS

This application is based on and claims the benefit of priority from the prior Japanese Patent Application No. 2005-221417, filed on Jul. 29, 2005; the entire contents of which are incorporated herein by reference.

### TECHNICAL FIELD

The present invention relates to a charge pump circuit of a switching source.

### BACKGROUND

### Description of Related Art

A charge pump circuit used for a switching source employs a coil or a control integrated circuit (IC) (for example, refer to JP-A-9-21523).

A related-art voltage conversion circuit of the switching source using the charge pump circuit will be described with reference to the accompanying drawings. FIG. 1 is a circuit diagram showing an example of a booster type voltage conversion circuit of a switching source.

As shown in FIG. 1, the related-art voltage conversion circuit 100 of the switching source is a booster type DC/DC converter. A source voltage V_{CC} is applied to one end of a primary winding wire N₁ of a transformer T, and a drain of a switching transistor Q₁₀₁ of an n-channel field effect transistor (FET) is connected to the other end of the primary winding wire N₁. At a secondary side of the transformer T, one end of a secondary winding wire N₂, on the other hand, is serially connected to a diode D₁₀₁ and a drain of a transistor Q₁₀₂ through a boosting coil L. In addition, a diode D₁₀₂, of which an anode is connected to the coil L and the drain of the transistor Q₁₀₂ is connected to a capacitor C₁₀₂ for smoothing a boosted output voltage V₂. A control IC 102 for controlling the boosting transistor Q₁₀₂ is employed by the related-art voltage conversion circuit.

### SUMMARY

However, in general, a charge pump circuit of a related-art switching source employs the aforementioned booster type DC/DC converter when it is difficult to add a winding wire to a transformer T, in case that an output voltage higher than a plurality of secondary rectified outputs of the switching source is obtained.

Since the booster type DC/DC converter employs the aforementioned coil L or the control IC 102, the booster type DC/DC converter is expensive and needs large space. In addition, power loss due to the coil L is large.

A control integrated circuit (IC) for the charge pump circuit, which does not employ a coil, is also generally sold, and however, an output current from this control IC for the charge pump circuit is about 100-200 mA. This control IC for the charge pump circuit cannot output a large current.

There are problems that the booster type DC/DC converter is expensive and needs large space, the power loss due to the coil is large, or a large current cannot be obtained from the control IC of the charge pump circuit, since the booster type DC/DC converter employs the aforementioned coil L or the control IC.

The present invention has been made in view of the above circumstances and provides a charge pump circuit of a switching source.

According to an aspect of the present invention, a charge pump circuit of a switching source is provided. In the charge pump circuit, a rectifier diode at a secondary side of a transformer is located at a ground side of a secondary winding wire, and a part of a transformer voltage generated at a cathode of the rectifier diode is used as a voltage for driving a gate of a boosting transistor which is connected between a capacitor for a charge pump and a source of which the voltage is added to charges accumulated in the capacitor.

### BRIEF DESCRIPTION OF THE DRAWINGS

These and other objects and advantages of this invention will become more fully apparent from the following detailed description taken with the accompanying drawings in which:

FIG. 1 is a circuit diagram showing a related-art voltage conversion circuit of a switching source;

FIG. 2 is a circuit diagram showing a charge pump circuit of a switching source according to a first embodiment of the present invention;

FIG. 3 is an example of waveforms of values measured at the charge pump circuit of the switching source according to the first embodiment;

FIG. 4 is a circuit diagram showing a charge pump circuit of a switching source according to a second embodiment of the present invention;

FIG. 5 is a circuit diagram showing a charge pump circuit of a switching source according to a third embodiment of the present invention; and

FIG. 6 is a circuit diagram showing a charge pump circuit of a switching source according to a fourth embodiment of the present invention.

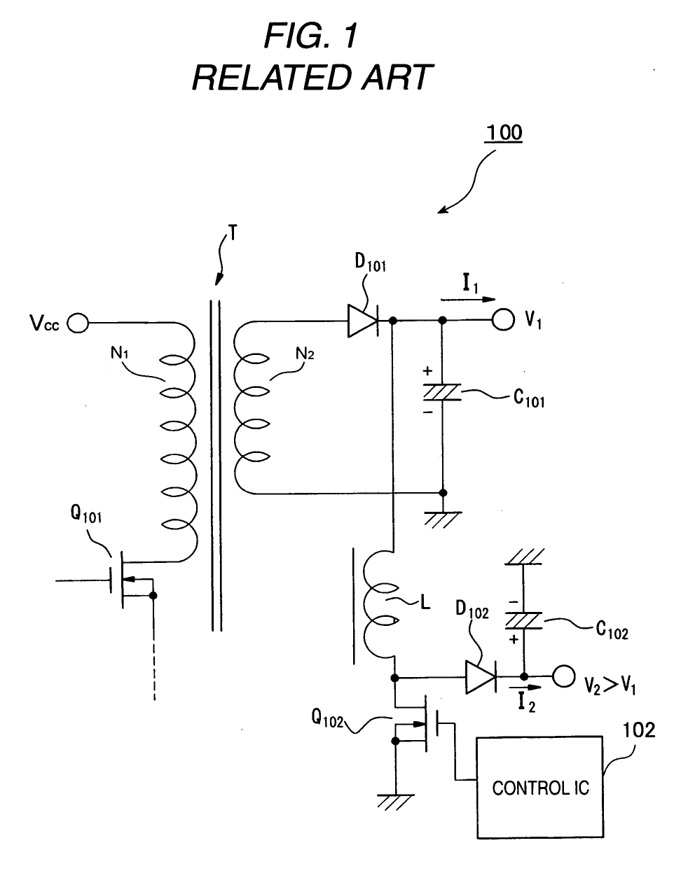

### DESCRIPTION OF THE EMBODIMENTS

Hereinafter, the charge pump circuit of the switching source according to embodiments will be described in detail, in reference to the accompanying drawings.

### The First Embodiment of the Present Invention

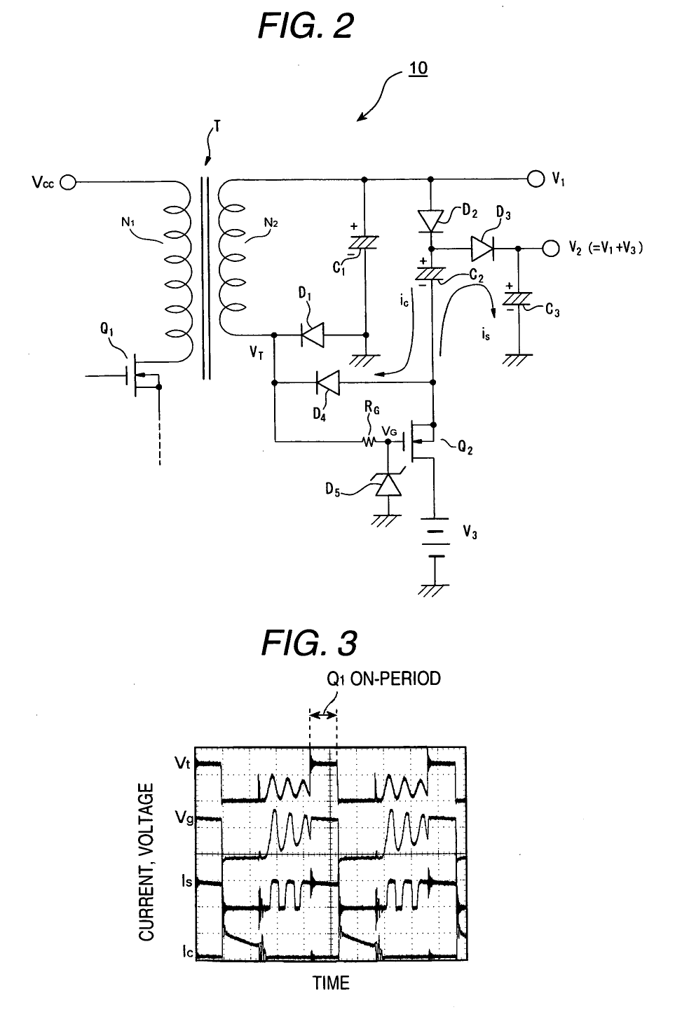

FIG. 2 is a circuit diagram showing a charge pump circuit of a switching source according to a first embodiment of the present invention.

As shown in FIG. 2, in a charge pump circuit 10 of a switching source, a source voltage V_{CC} is applied to one end of a primary winding wire N₁ of a transformer T, and a drain of a switching transistor Q₁ of an n-channel field effect transistor (FET) is connected to the other end of the primary winding wire N₁.

At a secondary side of the transformer T, on the other hand, one end (close to the output voltage V₁) of a secondary winding wire N₂ is connected to an electrolytic capacitor C₁ for smoothing the output voltage V₁ at the secondary side and an anode of a diode D₂, respectively. A cathode of the diode D₂ is connected to an anode of a diode D₃, and a cathode of the diode D₃ is connected to a boosted output voltage V₂. In addition, the cathode of diode D₂ is connected to the electrolytic capacitor C₂, and the cathode of the diode D₃ is connected to the electrolytic capacitor C₃.

In addition, the cathode of diode D₂ is connected to a source of a boosting transistor Q₂ of an n-channel FET and an anode of a diode D₄, respectively, via the electrolytic capacitor C₂. A drain of the boosting transistor Q₂ is connected to a direct current (DC) source V₃, and a gate of the boosting transistor Q₂ is connected to a cathode of a zener diode D₅ of which an anode is grounded and connected to the other end of the secondary winding wire N₂ of the transformer T via a resistor R_{G}. In addition, the other end (to the ground side) of the secondary winding wire N₂ of the transformer T is connected to the cathodes of the rectifier diode D₁ and the diode D₄, respectively.

Owing to the charge pump circuit 10, the boosted output voltage V₂ at the secondary side of V₂=V₁+V₃ is obtained.

FIG. 3 is an example of waveforms of a voltage V_{T} at the other end of the transformer T, a gate voltage V_{G} of a transistor Q₂, a charging current i_{S} of an electrolytic capacitor C₃, and a charging current i_{C} of a capacitor C₂, which are measured at the charge pump circuit of the switching source, according to the first embodiment.

In the waveform of the voltage V_{T} shown in FIG. 3, fluctuations before an on-period of the transistor Q₁ are caused by the resonance between the primary inductance of the primary winding wire N₁ of the transformer T and the drain capacitance of the transistor Q₁.

In addition, fluctuations during the beginning of the on-period of the transistor Q₁ are caused by leakage inductance.

The source V₃ may not be a DC source. In the following second to fourth embodiments, a rectifier element may be connected to the source V₃ in order to extract a DC source from the other secondary winding wire of the transformer T.

### The Second Embodiment of the Present Invention

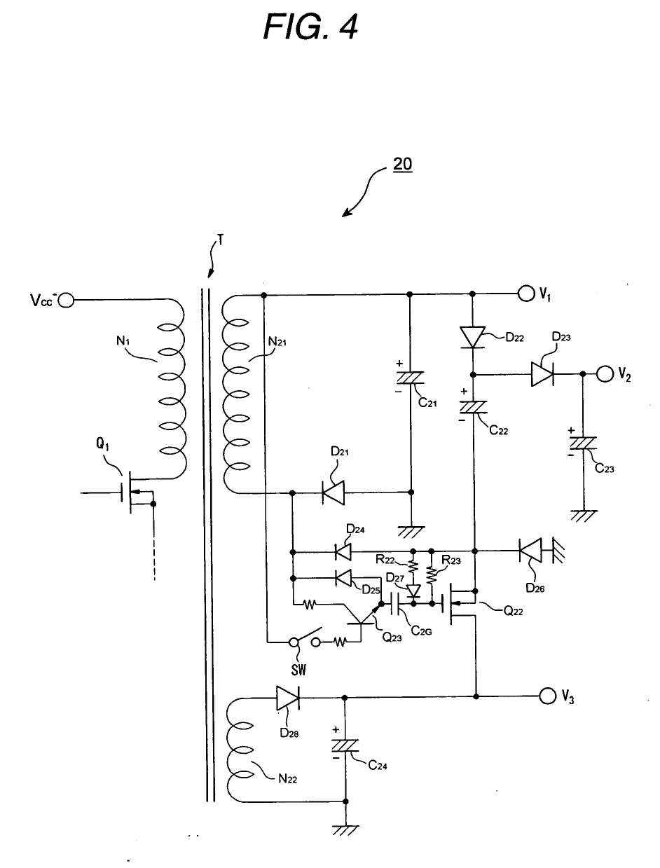

FIG. 4 is a circuit diagram showing a charge pump circuit of a switching source according to a second embodiment of the present invention.

As shown in FIG. 4, like in the first embodiment of the present invention, in a charge pump circuit 20 of a switching source, a source voltage V_{CC} is applied to one end of a primary winding wire N₁ of a transformer T, and a drain of a switching transistor Q₁ of an n-channel FET is connected to the other end of the primary winding wire N₁.

At a secondary side of the transformer T, on the other hand, one end (close to the output voltage V₁) of a secondary winding wire N₂₁ is connected to an electrolytic capacitor C₂₁ for smoothing the output voltage V₁ at the secondary side and an anode of a diode D₂₂, respectively. A cathode of the diode D₂₂ is connected to an anode of a diode D₂₃, and a cathode of the diode D₂₃ is connected to a boosted output voltage V₂.

In addition, the cathode of the diode D₂₂ is connected to the electrolytic capacitor C₂₂, and the cathode of the diode D₂₃ is connected to the electrolytic capacitor C₂₃.

In addition, the cathode of the diode D₂₂ is connected to a source of a boosting transistor Q₂₂ of an n-channel FET, an anode of a diode D₂₄, and a cathode of a diode D₂₆, respectively, via the electrolytic capacitor C₂₂. A gate of the boosting transistor Q₂₂ is connected to an emitter of an npn bipolar transistor Q₂₃ and an anode of a diode D₂₅, respectively, via a capacitor C_{2G}. In addition, a resistor R₂₂ and a diode D₂₇ are serially connected between the gate and the source of the boosting transistor Q₂₂, and a resistor R₂₃ is connected therebetween in parallel.

In addition, a collector of a transistor Q₂₃ is connected to the other end (to the ground side) of the secondary winding wire N₂₁ of the transformer T, via a resistor R₂₁. A base of the transistor Q₂₃ is connected to the one end of the secondary winding wire N₂₁ of the transformer T, via a switch SW. Furthermore, cathodes of the diodes D₂₄ and D₂₅ are connected to the other end (to the ground side) of the secondary winding wire N₂₁.

Then, the drain of the boosting transistor Q₂₂ is connected to a source voltage V₃ extracted from the other secondary winding wire N₂₂ of the transformer T. One end of the secondary winding wire N₂₂ is connected to an anode of a diode D₂₈, and the source voltage V₃ is output from the cathode of the diode D₂₈. A electrolytic capacitor C₂₄ for smoothing the source voltage V₃ is connected between the cathode of the diode D₂₈ and the other end (to the ground side) of the secondary winding wire N₂₂.

In the second embodiment of the present invention, the transistor Q₂₃ clamps a gate voltage V_{GS}, with small power loss, not to enlarge the gate voltage of the boosting transistor Q₂₂. In addition, since an operation of the boosting transistor Q₂₂ can be controlled by the switch SW, the power loss can be a zero by turning off the switch SW with respect to the voltage transistor Q₂₂ when the switching source is in a standby mode.

In the second embodiment of the present invention, for example, when it is assumed that V₁=12V and V₃=6.5V, V₂ is 17V. In addition, an output current of the boosted output voltage V₂ can be more than 1A.

In addition, the gate of the boosting transistor Q₂₂ is not directly connected to the emitter of the transistor Q₂₃ but via a capacitor C_{G} to secure the safety of the charge pump circuit when the boosting transistor Q₂₂ malfunctions.

A rectifier diode D₂₁ may be a synchronous rectifier FET.

In addition, a diode D₂₆ is used to discharge the capacitor C₂₂, and therefore, the diode D₂₆ does not influence circuit operations.

### The Third Embodiment of the Present Invention

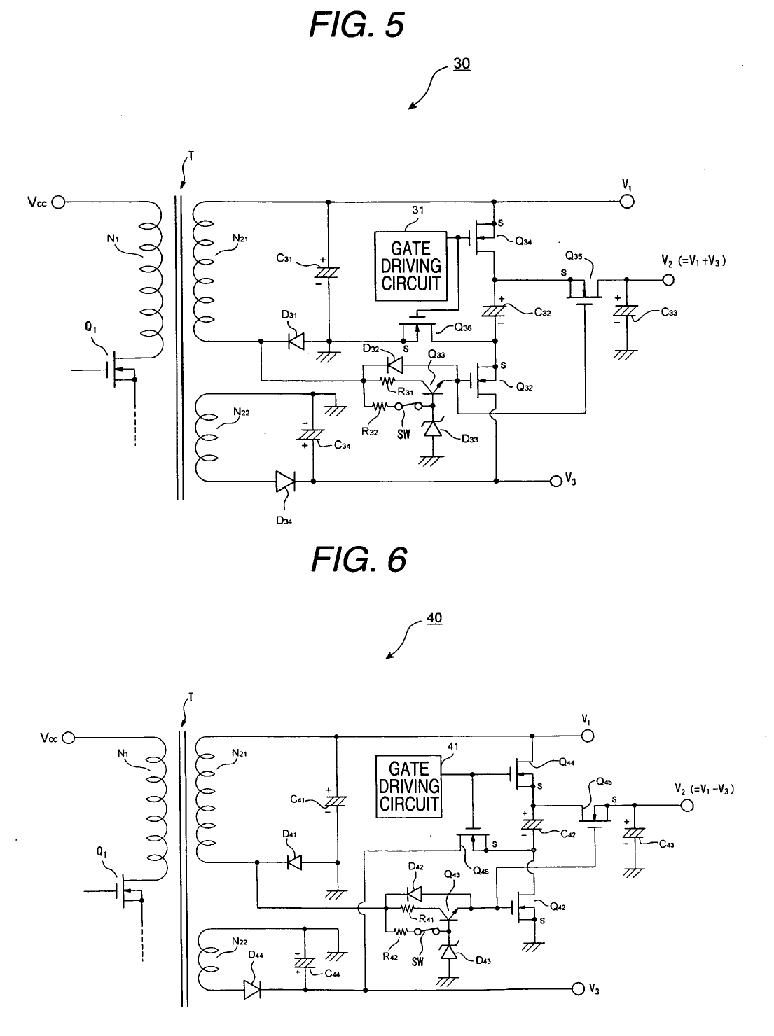

FIG. 5 is a circuit diagram showing a charge pump circuit of a switching source according to a third embodiment of the present invention.

In the third embodiment of the present invention, the diodes D₂₂, D₂₃, and D₂₄ in the aforementioned second embodiment of the present invention are replaced with transistors (n-channel FETs) Q₃₄, Q₃₅, and Q₃₆, respectively.

As shown in FIG. 5, like in the first embodiment of the present invention, in a charge pump circuit 30 of a switching source, a source voltage V_{CC} is applied to one end of a primary winding wire N₁ of a transformer T, and a drain of a switching transistor Q₁ of an n-channel FET is connected to the other end of the primary winding wire N₁.

On the other hand, at a secondary side of the transformer T, one end (close to the output voltage V₁) of a secondary winding wire N₂₁ is connected to an electrolytic capacitor C₃₁ for smoothing the output voltage V₁ at the secondary side and a source of a transistor Q₃₄, respectively. A drain of the transistor Q₃₄ is connected to a source of the transistor Q₃₅, and a drain of the transistor Q₃₅ is connected to the boosted output voltage V₂.

In addition, the drain of the transistor Q₃₄ is connected to an electrolytic capacitor C₃₂, and the drain of the transistor Q₃₅ is connected to an electrolytic capacitor C₃₃.

In addition, the drain of the transistor Q₃₄ is connected to the source of a boosting transistor Q₃₂ and a drain of the transistor Q₃₆, respectively, via the electrolytic capacitor C₃₂.

The gate of the boosting transistor Q₃₂ (npn bipolar transistor) is connected to an emitter of a transistor Q₃₃ and an anode of a diode D₃₂, respectively, and the source of the boosting transistor Q₃₂ is connected to a gate of the transistor Q₃₅.

In addition, a base of the transistor Q₃₃ is connected to the other end of the secondary winding wire N₂₁ of the transformer T via serially connected switch SW and resistor R₃₂. A collector of the transistor Q₃₃ is connected to the other end (to the ground side) of the secondary winding wire N₂₁ of the transformer T via a resistor R₃₁. Cathodes of the diodes D₃₁ and D₃₂ are connected to the other end (to the ground side) of the secondary winding wire N₂₁, respectively. Gates of the transistors Q₃₅ and Q₃₆ are driven by a gate driving circuit 31.

Then, a drain of the boosting transistor Q₃₂ is connected to a source voltage V₃ extracted from the other secondary winding wire N₂₂ of the transformer T. One end of the secondary winding wire N₂₂ is connected to an anode of a diode D₃₄, and the source voltage V₃ is output from the cathode of the diode D₃₄. An electrolytic capacitor C₃₄ for smoothing the source voltage V₃ is connected between the source voltage V₃ and the end (to the ground) of the secondary winding wire N₂₂.

In the present embodiment of the present invention, since the diodes D₂₂, D₂₃, and D₂₄ in the aforementioned second embodiment of the present invention are replaced with transistors (n-channel FETs) Q₃₄, Q₃₅, and Q₃₆, respectively, power loss due to the diodes is prevented to achieve a high efficiency. A large current can be extracted from the circuit. In the present embodiment, the transistors Q₃₂, Q₃₄, Q₃₅, and Q₃₆ are n-channel FETs.

A voltage for driving the gate of the transistor Q₃₄ is set to a voltage higher than the output voltage V₁ by 5V or more and a voltage for driving the gate of the transistor Q₃₅ is set to a voltage higher than the output voltage V₂ by 5V or more. In addition, the gates of the transistors Q₃₄ and Q₃₆ are driven by the gate driving circuit 31 so that a time point when the gates of the transistors Q₃₄ and Q₃₆ are driven is equal to a time point when the diode D₃₁ is turned on.

When the gate driving circuit 31 cannot be constructed, the transistors Q₃₄ and Q₃₆ may be replaced with the diodes D₂₂ and D₂₄ in FIG. 4.

### The Fourth Embodiment of the Present Invention

FIG. 6 is a circuit diagram showing a charge pump circuit of a switching source according to a fourth embodiment of the present invention.

As shown in FIG. 6, like in the first embodiment of the present invention, in a charge pump circuit 40 of a switching source, a source voltage V_{CC} is applied to one end of a primary winding wire N₁ of a transformer T, and a drain of a switching transistor Q₁ of an n-channel FET is connected to the other end of the primary winding wire N₁.

On the other hand, at a secondary side of the transformer T, one end (close to the output voltage V₁) of a secondary winding wire N₂₁ is connected to an electrolytic capacitor C₄₁ for smoothing the output voltage V₁ at the secondary side and a drain of a transistor Q₄₄, respectively. A source of the transistor Q₄₄ is connected to a drain of the transistor Q₄₅, and a source of the transistor Q₄₅ is connected to the boosted output voltage V₂.

In addition, the drain of the transistor Q₄₄ is connected to an electrolytic capacitor C₄₂, and the source of the transistor Q₄₅ is connected to an electrolytic capacitor C₄₃. The source of the transistor Q₄₄ is connected to the drain of a boosting transistor Q₄₂ and a source of the transistor Q₄₆, respectively, via a capacitor C₄₂.

The gate of the boosting transistor Q₄₂ (npn bipolar transistor) is connected to an emitter of a transistor Q₄₃ and an anode of a diode D₄₂, respectively, and the drain of the boosting transistor Q₄₂ is connected to a gate of the transistor Q₄₅. A base of the transistor Q₄₃ is connected to the other end (to the ground side) of the secondary winding wire N₂₁ of the transformer T via serially connected switch SW and resistor R₄₂. A collector of the transistor Q₄₃ is connected to the other end (to the ground side) of the secondary winding wire N₂₁ of the trans former T via a resistor R₄₁. Cathodes of the diodes D₄₁ and D₄₂ are connected to the other end (to the ground side) of the secondary winding wire N₂₁.

Gates of the transistors Q₄₅ and Q₄₆ are driven by a gate driving circuit 41.

Then, a source of the boosting transistor Q₄₂ is grounded.

In addition, a drain of the transistor Q₄₆ is connected to the source voltage V₃. One end of a secondary winding wire N₂₂ is grounded, and the other end of the secondary winding wire N₂₂ is connected to an anode of a rectifier diode D₄₄. The source voltage V₃ is output from a cathode of the rectifier diode D₄₄. An electrolytic capacitor C₄₄ for smoothing the source voltage V₃ is connected between the source voltage V₃ and the end (to the ground) of the secondary winding wire N₂₂.

The present embodiment of the present invention is obtained by connecting the drain of the transistor Q₃₆ in the third embodiment of the present invention to the source V₃ and connecting the source electrodes and drain electrodes of the transistors Q₃₂, Q₃₄, Q₃₅, and Q₃₆, in reverse-order, with respect to the third embodiment of the present invention. Thereby, the output voltage V₂ is obtained as the voltage difference between the output voltage V₁ and the source voltage V₃, that is, V₂=V₁−V₃.

As described above, according to an aspect of the present invention, a charge pump circuit of a switching source is provided. In the charge pump circuit, a rectifier diode D₁ (D₂₁, D₃₁, and D₄₁) at a secondary side of a transformer T is located at a ground side of a secondary winding wire N₂ (N₂₁), and a part of a transformer voltage generated at a cathode of the rectifier diode D₁ (D₂₁, D₃₁, and D₄₁) is used as a voltage for driving a gate of a boosting transistor Q₂ (Q₂₂, Q₃₂, and Q₄₂) which is connected between a capacitor C₂ (C₂₂, C₃₂, and C₄₂) for a charge pump and a source of which the voltage is added to charges accumulated in the capacitor C₂ (C₂₂, C₃₂, and C₄₂).

According to the above-embodiments, a charge pump circuit of a switching source is provided. In the charge pump circuit, a rectifier diode at a secondary side of a transformer is located at a ground side of a secondary winding wire, and a part of a transformer voltage generated at a cathode of the rectifier diode is used as a voltage for driving a gate of a boosting transistor which is connected between a capacitor for a charge pump and a source of which the voltage is added to charges accumulated in the capacitor.

That is, there is no power loss due to a coil, since the coil is not used for the charge pump circuit. In addition, a control IC for the charge pump circuit is not necessary, and therefore, a sum of the two voltages is simply extracted as the boosted voltage output. Furthermore, a relatively high current (for example, more than 1A) can be output.

What is claimed is:

1. A charge pump circuit of a switching source, comprising:
a transformer;
a rectifier diode of a secondary side of the transformer located at a ground side of a secondary winding wire;
a capacitor for a charge pump;
a power source of which a voltage is applied so as to charge accumulated in the capacitor; and
a boosting transistor connected between the capacitor and the power source, wherein a transformer voltage generated at a cathode side of the rectifier diode is at least partially used as a gate-driving voltage of the boosting transistor.

2. The charge pump circuit according to claim 1, wherein the power source is a DC source-whi-ch is connected to a drain of the boosting transistor.

3. The charge pump circuit according to claim 1, wherein the power source is extracted from a secondary winding wire except the transformer.

4. The charge pump circuit according to claim 3, wherein a gate of the boosting transistor is connected to an emitter of a bipolar transistor via a capacitor, and
wherein a cathode of the rectifier diode is connected to a collector of the bipolar transistor.

5. The charge pump circuit according to claim 4, wherein the rectifier diode is a synchronous rectifier field effect transistor.

6. The charge pump circuit according to claim 3, wherein a diode which is located between an output voltage of the secondary winding wire of the transformer and a boosted output voltage is replaced with a transistor.

7. The charge pump circuit of the switching source according to claim 6, wherein the transistor is an n-channel Field effect transistor.

8. The charge pump circuit of the switching source according to claim 6, wherein a source of the transistor is connected to the output voltage of the secondary winding wire of the transformer.

9. The charge pump circuit according to claim 6, wherein a drain of the transistor is connected to the output voltage of the secondary winding wire of the transformer, and wherein the boosted output voltage is a voltage difference between the output voltage and the voltage of the source.
